(19) United States
(12) Patent Application Publication
(10) Pub. No.: US 2014/0144840 A1
(43) Pub. Date: May 29, 2014

(54) SEQUENCING BATCH TYPE OR BATCH TYPE WATER-FILTERING APPARATUS AND METHOD OF OPERATING THE SAME

(71) Applicants: Youn Kook Kim, Seoul (KR); Ho Chan Jung, Seoul (KR); Ja Yeon Song, Seoul (KR)

(72) Inventors: Youn Kook Kim, Seoul (KR); Ho Chan Jung, Seoul (KR); Ja Yeon Song, Seoul (KR)

(73) Assignee: COWAY CO., LTD, Kongju-si (KR)

(21) Appl. No.: 14/233,420

(22) PCT Filed: Dec. 30, 2011
(86) PCT No.: PCT/KR2011/010364

§ 371 Date: Jan. 17, 2014

(30) Foreign Application Priority Data
Jul. 28, 2011 (KR) 10-2011-0075006
Dec. 14, 2011 (KR) 10-2011-0134865

(51) Int. Cl. C02F 1/44

(52) U.S. Cl. CPC C02F 1/44
USPC 210/636; 210/196; 210/134; 210/104

(57) ABSTRACT

Provided are a sequencing batch type or batch type water-filtering apparatus and a method of operating the apparatus. The apparatus includes a raw water inflow pump and a membrane module including tubular type membranes arrayed in series. Accordingly, the apparatus maintains an appropriate cross-flow velocity, and is automatically controlled.

### TECHNICAL FIELD

The present invention relates to a sequencing batch type or batch type water-filtering apparatus and a method of operating the apparatus, which maintains an appropriate cross-flow velocity and is automatically controlled.

### BACKGROUND ART

Membranes perform a typical filtration operation for selectively allowing a specific component through, to thereby separate undissolved particles, and may be formed of a special material to separate mixed gas or a material dissolved in a liquid.

Membranes are classified into a microfiltration membrane (MF), an ultra filtration membrane (UF), a nano filtration membrane (NF), a reverse osmosis membrane (RO), an ion exchange (IE), an electrolyte dialysis (ED), a gas separation/PV (GAS), and a hem dialysis, according to their performances, and they are appropriately selected according to their purposes.

In addition, membranes may be classified into a spiral-wound membrane, a hollow-fiber membrane, a tubular type membrane, a plate and frame type membrane, and a monolith type membrane, according to their shapes.

Tubular type membranes have a shape with pipe-shaped membrane elements in a pressure-resistant container, and may be disposed within a high pressure-resistant porous tube having a diameter ranging from about 12 to 25 mm. High pressure water is introduced to a tube of a tubular type membrane, filtered produced water is discharged to the outside through the tubular type membrane, and concentrated water remaining in the tube is circulated through an end thereof.

A water-treating apparatus using membrane filtration, which is disclosed in Korean Patent Registration No. 10-0420763, includes tubular type membranes constituting a unit, and extending in the same direction within a pipe having a certain length to constitute a membrane module.

A supply passage of the tubular type membrane has a greater inlet than that of a typical membrane, and the tubular type membrane increases flow speed of raw water, and thus, is efficiently resistant to fouling. However, since the flow speed is increased, energy consumption is increased.

Particularly, since a water-treating apparatus including tubular type membranes should maintain an initial cross-flow velocity, a high capacity pump is required. In this case, heat from the pump leads to increase the temperature of raw water. Thus, an ad-ditional device such as a heat exchanger may be disposed at the front of a raw water tank to prevent the temperature increase of raw water. Furthermore, it is difficult to automatically control an operation of the tubular type membranes.

### DISCLOSURE OF INVENTION

### Technical Problem

Accordingly, the present invention is directed to an apparatus, which substantially obviates one or more problems due to limitations and disadvantages of the related art. The apparatus includes tubular type membranes arrayed in series to maintain a cross-flow velocity, and thus, the number of the tubular type membranes is substantially not limited. Further, the apparatus includes an automatic adjusting valve and a high capacity pump to maintain the cross-flow velocity, thereby automatically controlling a filtering operation of the tubular type membranes.

An object of the present invention is to provide a sequencing batch type or batch type water-filtering apparatus that can be operated using one raw water inflow pump, without using a separate heat exchanger.

Another object of the present invention is to provide a method of operating the apparatus, which maintains a constant cross-flow velocity and produces a desired amount of water for a short time.

### Solution to Problem

According to an aspect of the present invention, there is provided a sequencing batch type or batch type water-filtering apparatus including: a raw water storage tank for storing raw water; an inflow raw water tank connected to the raw water storage tank through a pipe, the raw water and circulation water being introduced to the inflow raw water tank; a membrane module connected to the inflow raw water tank through a pipe, and including a plurality of tubular type membranes; a raw water inflow pump connected to the pipe connecting the inflow raw water tank to the membrane module to introduce the raw water and the circulation water from the inflow raw water tank to the membrane module; a produced water storage tank connected to a side of the membrane module through a pipe to store water produced through a filtering operation of the membrane module; a circulation line connected to another side of the membrane module through a pipe to introduce concentrated water, generated through the filtering operation, as the circulation water to the inflow raw water tank; a discharge line for discharging a portion of mixed water of the raw water and the circulation water in the inflow raw water tank, as discharge water to an outside; and an automatic controller for controlling the production of the produced water and the discharge of the discharge water.

The sequencing batch type or batch type water-filtering may further include: a raw water flow meter and a first automatic valve on the pipe connecting the raw water storage tank to the inflow raw water tank to control the introduction of the raw water; a circulation water flow meter and a second automatic valve on the pipe connecting the membrane module to the inflow raw water tank to measure a flow rate of the circulation water; a produced water flow meter on the pipe connecting the membrane module to the produced water storage tank to measure a flow rate of the produced water; and a third automatic valve on the discharge line to measure a flow rate of the discharge water.

According to another aspect of the present invention, there is provided a method of operating the sequencing batch type or batch type water-filtering apparatus, which includes the raw water storage tank, the inflow raw water tank, the raw water inflow pump, the membrane module including the tubular type membrane arrayed in series, and the produced water storage tank, the method including: passing raw water, supplied from the raw water storage tank, through the membrane module via the inflow raw water tank, by using the raw water inflow pump; discharging water produced through the passing through of the raw water, to an outside; transferring concentrated water as circulation water to the inflow raw water tank through the circulation line; and discharging a portion of mixed water including the raw water and the circulation water in the inflow raw water tank, to the outside, wherein, when water is produced again after a backwashing operation, an initial degree of opening of a second automatic valve in the circulation line is adjusted to maintain a constant cross-flow velocity, and the rotation number of the raw water inflow pump is adjusted to control an amount of the produced water.

### Advantageous Effects of Invention

According to the embodiment of the present invention, the water-filtering apparatus includes one raw water inflow pump to produce water without a separate heat exchanger.

In addition, one raw water inflow pump increases the temperature of a membrane, thereby improving performance of the membrane. The temperature of raw water is easily controlled using circulation water, to thereby maximize the performance of the membrane. Moreover, the water-filtering apparatus can be miniaturized and simplified, and a backwashing period can be increased.

Specifically, water can be automatically produced by monitoring a valve and a sensor installed on each component, and the degree of opening of the second automatic valve and the rotation number of the raw water inflow pump are simultaneously adjusted to control the cross-flow velocity and the amount of produced water, thereby producing a desired amount of water for a short time.

Using this apparatus can be produced a concentrated water from raw water, if necessary, adjusting an amount of introduced raw water according to a set temperature and a set concentration.

### BRIEF DESCRIPTION OF DRAWINGS

FIG. 1 is a schematic view illustrating a water-filtering apparatus according to an embodiment of the present invention.

FIG. 2 is a flowchart illustrating an operation method using the apparatus of FIG. 1.

FIG. 3 is a graph illustrating membrane pressure differences according to temperature in a water-filtering apparatus according to an embodiment of the present invention.

FIG. 4 is a flowchart illustrating a control of concentrated water and discharge water generated by treating raw water in a water production process according to an embodiment of the present invention.

FIG. 5 is a flowchart illustrating a control of concentrated water and discharge water generated by concentrating raw water according to an embodiment of the present invention.

### MODE FOR THE INVENTION

Reference will now be made in detail to the embodiments of the present invention, examples of which are illustrated in the accompanying drawings.

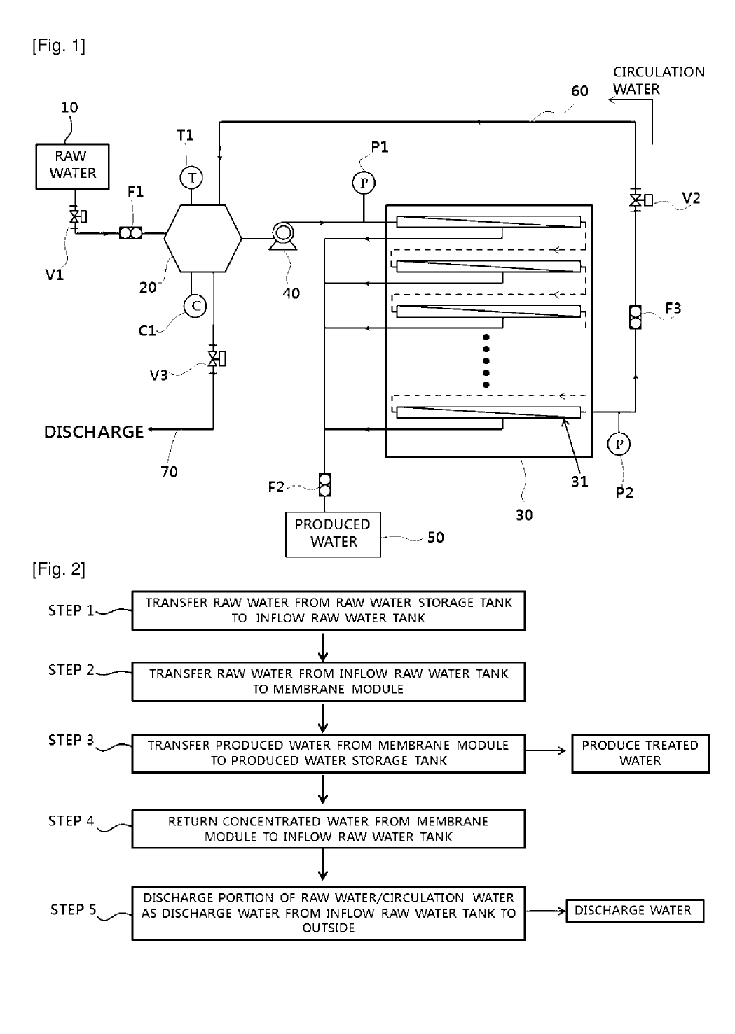

FIG. 1 is a schematic view illustrating a water-filtering apparatus according to an embodiment of the present invention.

Referring to FIG. 1, the water-filtering apparatus includes a raw water storage tank 10, an inflow raw water tank 20, a membrane module 30, a raw water inflow pump 40, a produced water storage tank 50, a circulation line 60, and a discharge line 70.

The raw water storage tank 10 stores raw water, and may be constituted by a typical storage device.

The inflow raw water tank 20 is connected to the raw water storage tank 10 through a pipe, and receives raw water from the raw water storage tank 10, and circulation water from the circulation line 60 that will be described later.

The pipe connecting the raw water storage tank 10 to the inflow raw water tank 20 is provided with a first automatic valve V1 and a raw water flow meter F1 for controlling an inflow of raw water, thereby automatically controlling raw water introduced from the raw water storage tank 10.

A temperature sensor T1 for measuring temperature, a concentration sensor C1 for measuring concentration, and a level sensor L1 for measuring a level of raw water are installed on the inflow raw water tank 20.

The first automatic valve V1 is turned on/off using a controller by monitoring the temperature sensor T1, the concentration sensor C1, and the level sensor L1.

The temperature sensor T1 measures the temperature of mixed water of circulation water and raw water within the inflow raw water tank 20. When the temperature of the mixed water is equal to or higher than a set temperature, low temperature raw water is introduced from the raw water storage tank 10 to decrease the temperature of the mixed water. When the temperature of the mixed water is lower than the set temperature, the concentration of the mixed water is measured, and the mixed water is discharged. To control the inflow and discharge of the raw water according to the set temperature, the temperature measured by the temperature sensor T1 is transmitted to the first automatic valve V1 by the separate controller, so that the first automatic valve V1 can be turned on/off.

The concentration sensor C1 is used to recover a concentrate from the mixed water. Particularly, when the concentration of mixed water of raw water and circulation water within the inflow raw water tank 20 is measured, if the concentration of the mixed water is equal to or higher than a set concentration, the mixed water is transferred to a separate recovery tank connected to the inflow raw water tank 20, and is discharged to the outside. If the concentration of the mixed water is lower than the set concentration, the water-filtering apparatus is continually operated until the concentration reaches the set concentration. To control the operation of the water-filtering apparatus and the discharge of the mixed water according to the set concentration, the concentration measured by the concentration sensor C1 is transmitted to the first automatic valve V1 and a third automatic valve V3 to be described later by the separate controller, so that the first and third automatic valves V1 and V3 can be turned on/off.

The level sensor L1 measures the level of mixed water of circulation water and raw water within the inflow raw water tank 20 to adjust an inflow of raw water from the raw water storage tank 10. To this end, the level measured by the level sensor L1 is transmitted to the first automatic valve V1 by the separate controller, so that the first automatic valve V1 can be turned on/off. That is, upper and lower limit levels of the mixed water within the raw water storage tank 10 are set, and the first automatic valve V1 is turned on to introduce raw water, or is turned off to block an inflow of raw water, thereby adjusting the level measured by the level sensor L1.

The raw water inflow pump 40 introduces mixed water of raw water and circulation water from the inflow raw water tank 20 to the membrane module 30, and is a high capacity pump. Particularly, a single high capacity pump can be provided by connecting membranes to one another in series within the membrane module 30, which will be described later.

Particularly, heat due to an operation of the raw water inflow pump 40 increases the temperature of a membrane, thereby improving performance of the membrane, that is, permeability thereof. However, an excessive temperature increase may degrade the performance of the membrane, and thus, the temperature of the membrane is controlled with the raw water inflow pump 40 since a separate heat exchanger is not provided in the current embodiment. Thus, raw water introduced to the membrane module 30 through the raw water inflow pump 40 is maintained at a constant temperature. To this end, the temperature of the raw water is monitored by the temperature sensor T1, and then, raw water is introduced from the raw water storage tank 10 to the inflow raw water tank 20 to maintain a set temperature. Accordingly, mixed water having a certain desired temperature increases permeability of tubular type membranes 31 within the membrane module 30.

The membrane module 30 is connected to the inflow raw water tank 20 through a pipe, and includes the plurality of tubular type membranes 31. Each plural of tubular type membranes 31 is connected to one another in series (see FIG. 1), and its required number is determined according to a pump capacity and an amount of produced water. The tubular type membranes 31 may be connected in parallel. However, in this case, pumps should be provided to the tubular type membranes 31, respectively, to obtain high cross-flow velocity. Thus, in the current embodiment, the tubular type membranes 31 are arrayed in series, and the raw water inflow pump 40 is provided as a single high capacity pump, in order to perform a filtering operation.

The raw water inflow pump 40 as a high capacity pump causes high cross-flow velocity within the tubular type membrane 31, thereby substantially preventing a clog of the tubular type membrane 31 due to a foreign substance. This advantage of the present invention cannot be guaranteed a module employing a plate and frame type membrane, a spiral-wound type membrane, or a hollow-fiber type membrane.

The material and dimensions of the tubular type membrane 31 are not limited within the scope of the present invention, and thus, any well-known tubular type membrane may be used as the tubular type membrane 31.

For example, a front pressure gauge P1 may be disposed at an inlet of the membrane module 30 through which mixed water is introduced, and a rear pressure gage P2 may be disposed at an outlet of the membrane module 30 through which concentrated water (circulation water) is discharged. Preferably, ones or tens of the tubular type membranes 31 may provide to maintain a pressure difference of about 0.1 kgf/cm² or higher between the front and rear pressure gauges P1 and P2. More preferably, the number of the tubular type membranes 31 may be 4 to 10, and most preferably 6 to 8 in series.

A portion of mixed water, which passes through the tubular type membranes 31, is produced water (that is, processed water), and the other thereof, which does not pass therethrough, is concentrated water (circulation water).

The membrane module 30 is connected to the produced water storage tank 50 through a pipe to collect produced water. In this case, the produced water is collected not through an outlet of the membrane module 30, but through respective outlets of the tubular type membranes 31. To this end, the tubular type membranes 31 are inde-pendently connected to the produced water storage tank 50 through pipes.

The pipe connecting the produced water storage tank 50 to the membrane module 30 is provided with a produced water flow meter F2 that measures the flow rate of produced water introduced from the membrane module 30. The rotation number of the raw water inflow pump 40 is controlled based on the measured flow rate of the produced water.

The concentrated water as circulation water is transferred to the circulation line 60. The concentrated water is transferred to the circulation line 60 not through each of the tubular type membranes 31, but through the last one of the tubular type membranes 31. Accordingly, water concentrated by the first one of the tubular type membranes 31 is filtered again by the second one of the tubular type membranes 31.

The circulation water is transferred from the membrane module 30 to the inflow raw water tank 20 through the circulation line 60. A circulation water flow meter F3 for measuring a flow rate of the circulation water, and a second automatic valve V2 for controlling a flow rate of the circulation water to maintain the circulation water at constant cross-flow velocity are installed on the circulation line 60.

The circulation water is introduced to the inflow raw water tank 20 through the circulation line 60, together with raw water. At this point, water including a solid material is discharged from mixed water of the raw water and the circulation water to the outside. The concentration sensor C1 disposed in the inflow raw water tank 20 finally determines whether the water including the solid material is discharged to the outside. The water including the solid material is discharged through the discharge line 70 connected to the inflow raw water tank 20.

The discharge line 70 is connected to an outlet. The third automatic valve V3 is installed on the discharge line 70 to control inflow and discharge of the discharge water. When the concentration sensor C1 senses that a concentration the mixed water within the inflow raw water tank 20 is equal to or higher than a certain value, the third automatic valve V3 is turned on/off.

The above-described configuration may include the separate controller for an automatic control, so that the water-filtering apparatus can perform an automatic operation.

The controller, which may be a well-known controller, controls: on/off operations of the first and third automatic valves V1 and V3, based on values measured by the temperature sensor T1, the concentration sensor C1, and the level sensor L1 within the inflow raw water tank 20; a degree of opening of the second automatic valve V2, based on a value measured by the circulation water flow meter F3; and the rotation number of the raw water inflow pump 40, based on a value measured by the produced water flow meter F2.

As described above, a sequencing batch type or batch type water-processing apparatus includes a raw water storage tank, an inflow raw water tank, a raw water inflow pump, a membrane module including tubular type membranes arrayed in series, and a produced water storage tank. The raw water inflow pump supplies raw water from the water storage tank to the membrane module through the inflow raw water tank. Then, a portion of the raw water, which passes through the membrane module, is discharged as produced water to the outside, and the other thereof is returned to the inflow raw water tank through an inner circulation line.

This will be described in more detail with reference to the accompanying drawings.

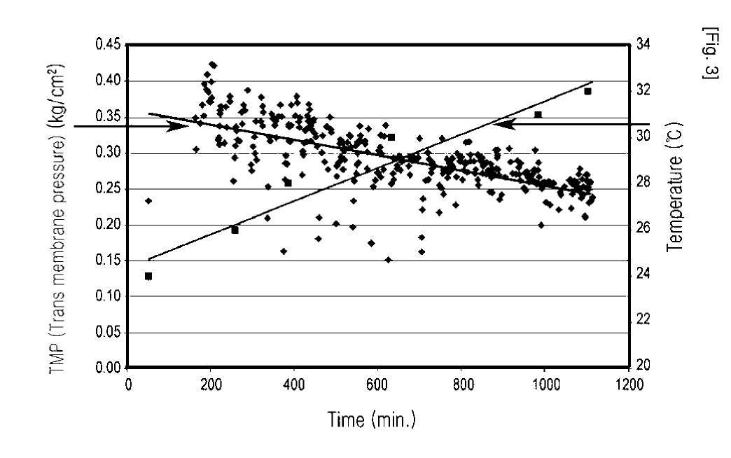

FIG. 2 is a flowchart illustrating an operation method using the apparatus of FIG. 1.

Referring to FIG. 2, water is produced as follows:

(step 1) raw water stored in the raw water storage tank 10 is introduced to the inflow raw water tank 20;

(step 2) the raw water in the inflow raw water tank 20 is transferred to the membrane module 30 including the tubular type membranes 31 arrayed in series, by using the raw water inflow pump 40;

(step 3) water produced from the membrane module 30 is transferred to the produced water storage tank 50;

(step 4) water concentrated in the membrane module 30 is circulated as circulation water to the inflow raw water tank 20 through the circulation line 60; and

(step 5) a portion of mixed water of raw water and the circulation water in the inflow raw water tank 20 is discharged as discharge water to the outside.

In more detail, raw water stored in the raw water storage tank 10 is introduced to the inflow raw water tank 20 in step 1.

The raw water may be surface water, underground water, sea water, home waste water, or high concentration industrial waste water, but is not limited thereto. For example, when the raw water is silicon waste water, produced water may be used as industrial water, and silicon may be reused after concentrating.

The temperature of the raw water in the inflow raw water tank 20 is measured by the temperature sensor T1 disposed therein. When the temperature of the raw water (and mixed water including circulation water) in the inflow raw water tank 20 is equal to or greater than a certain value, low temperature raw water is supplied. To this end, the on/off operations of the first automatic valve V1 are automatically controlled by the separate controller connected to the temperature sensor T1.

In step 2, the raw water in the inflow raw water tank 20 is transferred to the membrane module 30 including the plural of tubular type membranes 31 arrayed in series, by using the raw water inflow pump 40.

At this point, flow rates of the raw water, the circulation water, and the produced water are controlled to maintain a pressure difference of about 0.1 kgf/cm² or higher between the front and rear pressure gauges P1 and P2 connected to the membrane module 30.

The produced water flow meter F2, which will be described later, measures the flow rate of the produced water in order to adjust the rotation number of the raw water inflow pump 40. That is, an amount of the produced water is adjusted by controlling the amount of supplied water. To this end, the rotation number of the raw water inflow pump 40 is adjusted based on a signal value from the produced water flow meter F2, so that water can be produced at a flow rate input by a user.

That is, when the amount of the produced water is small, the rotation number of the raw water inflow pump 40 may be increased. When the amount of the produced water is large, the rotation number of the raw water inflow pump 40 may be decreased.

In this case, the rotation number of the raw water inflow pump 40 may be increased or decreased by about 0.1 to 0.5 Hz.

Particularly, a backwashing process is performed after producing water, and then, water is produced again. At this point, instead of an initial rotation number of 0 Hz, the rotation number in the latest process, which is stored in a programmable logic controller (PLC) is used to reduce time taken for finding a set value of the raw water inflow pump 40, thereby quickly controlling the amount of supplied water.

The water produced from the membrane module 30 is transferred to the produced water storage tank 50 in step 3.

Water produced from each of the tubular type membranes 31 in the membrane module 30 is transferred to the produced water storage tank 50 through the connecting pipe. The produced water may be used in various fields according to its purposes. For example, the produced water may be used as daily life water, agricultural water, industrial water, and public water such as in-stream water and recreational water.

As described in step 2, to adjust an amount of the produced water, the amount of the produced water is measured using the produced water flow meter F2, and the rotation number of the raw water inflow pump 40 is adjusted using the separate controller connected to the produced water flow meter F2.

In step 4, water concentrated in the membrane module 30 is circulated as circulation water to the inflow raw water tank 20 through the circulation line 60.

Raw water and the circulation water introduced to the inflow raw water tank 20 are supplied as mixed water to the membrane module 30 to produce processed water.

The flow rate of the circulation water is measured using the circulation water flow meter F3 installed on the circulation line 60, and the flow rate of the circulation water transferred to the inflow raw water tank 20 is controlled using the second automatic valve V2.

A high cross-flow velocity is required to prevent contamination of the tubular type membranes 31 within the membrane module 30. To this end, when a desired cross-flow velocity appropriate for the membrane module 30 is input using the circulation water flow meter F3, the second automatic valve V2 is automatically opened or closed to obtain the desired cross-flow velocity.

In this case, when an operation is performed in the state where the second automatic valve V2 is completely opened, it may be difficult to automatically obtain the desired cross-flow velocity. When an operation is performed in the state where the second automatic valve V2 is completely closed, the operation is linked with a produced water control, thus jeopardizing process stability. Thus, when the second automatic valve V2 is turned on again after each process, an initial degree of opening of the second automatic valve V2 is set to about 20 to 50%, preferably about 20 to 30%, and then, is decreased to obtain the desired cross-flow velocity, thereby quickly achieving the process stability when being linked with the produced water control.

The cross-flow velocity may be controlled using another method. That is, the amount of the produced water may be adjusted using the produced water flow meter F2 and the second automatic valve V2, and the flow rate of the circulation water, that is, the cross-flow velocity thereof can may be controlled by using the circulation water flow meter F3, and controlling the rotation number of the raw water inflow pump 40.

In step 5, a portion of mixed water of raw water and the circulation water in the inflow raw water tank 20 is discharged as discharge water to the outside.

The circulation water transferred to the inflow raw water tank 20 is concentrated water including a large amount of a solid material. Thus, when the concentrated water is introduced to the membrane module 30, filtering efficiency and performance are sig-nificantly degraded. Thus, when the mixed water in the inflow raw water tank 20 is concentrated to a certain value or higher, the concentrated water is discharged to the outside through the discharge line 70.

The discharged water includes a high concentration solid material, and may be discarded. When the solid material is a recyclable material such as silicon, the discharged material may be recovered.

To this end, a separate recovery tank (not shown) may be provided. In this case, the recovery tank is connected to the inflow raw water tank 20 and the discharge line 70 through a pipe. The third automatic valve V3 is installed on the discharge line 70 to discharge the concentrated water. The concentration of the mixed water is measured using the concentration sensor C1 disposed in the inflow raw water tank 20. When the concentration of the mixed water is a certain value or higher, the on/off operations of the third automatic valve V3 are controlled using the controller connected to the concentration sensor C1.

Methods of discharging water through the discharge line 70 may include a first method for treating raw water to obtain produced water, and a second method for concentrating raw water.

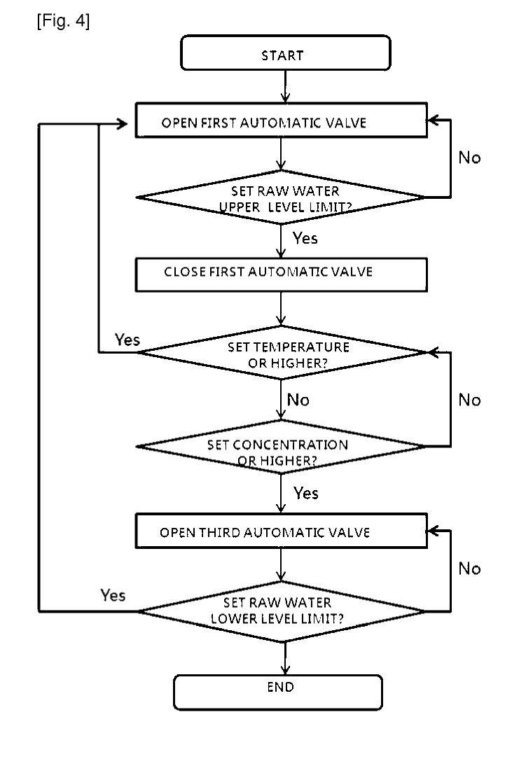

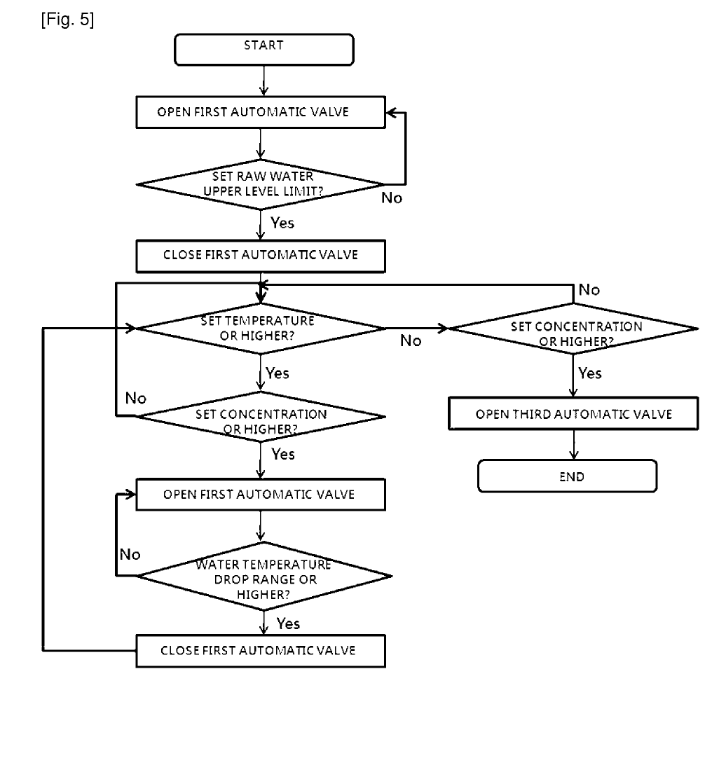

A control using the first method, and a control using the second method are illustrated in FIGS. 4 and 5, respectively.

In the first method, the first automatic valve V1 is turned on to continually introduce raw water to the inflow raw water tank 20 until the level sensor L1 senses a certain level, and then, the first automatic valve V1 is turned off.

Then, when the temperature sensor T1 in the inflow raw water tank 20 senses that the temperature of the introduced raw water is a set temperature or higher, the first automatic valve V1 is turned on again to introduce raw water and decrease the temperature.

When the temperature of the introduced raw water is lower than the set temperature, the concentration of the raw water is measured using the concentration sensor C1.

When the concentration of the raw water is lower than a set value, a process is continually performed. When the concentration of the raw water is equal to or higher than the set value, the third automatic valve V3 is turned on to discharge concentrated water through the discharge line 70.

Accordingly, when the level of the raw water in the inflow raw water tank 20 is decreased, raw water is continually introduced until the level sensor L1 senses the certain level, and then, the above described process is performed again.

In the second method, like in the first method, the first automatic valve V1 is turned on to continually introduce raw water to the inflow raw water tank 20 until the level sensor L1 senses a certain level, and then, the first automatic valve V1 is turned off.

Then, when the temperature sensor T1 in the inflow raw water tank 20 senses that the temperature of the raw water is lower than a set temperature, the concentration of the raw water is measured using the concentration sensor C1. When the measured concentration is equal to or higher than a desired set concentration, the third automatic valve V3 is turned on to discharge concentrated water through the discharge line 70.

However, when the temperature sensor T1 in the inflow raw water tank 20 senses that the temperature of the introduced raw water is the set temperature or higher, the concentration of the raw water is measured using the concentration sensor C1. When the concentration of the raw water is lower than the set concentration, raw water is introduced to protect the tubular type membranes 31.

At this point, unlike the first method in which raw water is introduced to the inflow raw water tank 20 until the level sensor L1 in the inflow raw water tank 20 senses the certain level, a small amount of raw water is introduced in a range not to affect the membrane module 30, while continually monitoring the temperature and concentration of the raw water.

Accordingly, the temperature of the raw water in the inflow raw water tank 20 is decreased. In this case, the difference between the temperature before introducing the raw water and the temperature after introducing the raw water may be equal to or smaller than a set temperature difference.

Since the water-filtering apparatus includes one raw water inflow pump to control the temperature of raw water by using circulation water, without using a separate heat exchanger, the water-filtering apparatus can be miniaturized and simplified, and a backwashing period can be also increased.

Particularly, when water is treated using the water-filtering apparatus, inner temperature of the inflow raw water tank 20 is measured using the temperature sensor T1, and TMP (Trans membrane pressure) according to the inner temperature are measured using the front and rear pressure gauges P1 and P2 of the membrane module 30, as illustrated in FIG. 3.

Referring to FIG. 3, as the water-filtering apparatus is operated, the inner temperature of the inflow raw water tank 20 is increased by the raw water inflow pump 40. Accordingly, the membrane pressure differences of the membrane module 30 decrease. This result shows that a filtering period of the membrane module 30 can be increased.

Specifically, water can be automatically produced by monitoring a valve and a sensor installed on each component, and the degree of opening of the second automatic valve and the rotation number of the raw water inflow pump are simultaneously adjusted to control the cross-flow velocity and the amount of produced water, thereby producing a desired amount of water for a short time.

When concentrated water is discharged, an amount of introduced raw water is adjusted according to a set temperature and a set concentration. Thus, concentrated water can be produced from raw water, if necessary.

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

The water-filtering apparatus and the method of operating the same according to the present invention can be applied to a water-filtering field.

1. A sequencing batch type or batch type water-filtering apparatus comprising:
a raw water storage tank for storing raw water;
an inflow raw water tank connected to the raw water storage tank through a pipe, the raw water and circulation water being introduced to the inflow raw water tank;
a membrane module connected to the inflow raw water tank through a pipe, and including a plurality of tubular type membranes;
a raw water inflow pump connected to the pipe connecting the inflow raw water tank to the membrane module to introduce the raw water and the circulation water from the inflow raw water tank to the membrane module;
a produced water storage tank connected to a side of the membrane module through a pipe to store water produced through a filtering operation of the membrane module;
a circulation line connected to another side of the membrane module through a pipe to introduce concentrated water, generated through the filtering operation, as the circulation water to the inflow raw water tank;
a discharge line for discharging a portion of mixed water of the raw water and the circulation water in the inflow raw water tank, as discharge water to an outside; and
an automatic controller for controlling the production of the produced water and the discharge of the discharge water.

2. The sequencing batch type or batch type water-filtering apparatus of claim 1, wherein the membrane module comprises 4 to 10 tubular type membranes arrayed in series, and a front and rear pressure gauges to measure a front and a rear pressure of the module.

3. The sequencing batch type or batch type water-filtering apparatus of claim 1, further comprising:
a raw water flow meter and a first automatic valve on the pipe connecting the raw water storage tank to the inflow raw water tank to control the introduction of the raw water;
a circulation water flow meter and a second automatic valve on the pipe connecting the membrane module to the inflow raw water tank to measure a flow rate of the circulation water;
a produced water flow meter on the pipe connecting the membrane module to the produced water storage tank to measure a flow rate of the produced water; and
a third automatic valve on the discharge line to measure a flow rate of the discharge water.

4. The sequencing batch type or batch type water-filtering apparatus of claim 3, wherein the batch type water-filtering apparatus controls on/off operations of the first and third valves, based on values measured by a temperature sensor, a concentration sensor, and a level sensor within the inflow raw water tank.

5. The sequencing batch type or batch type water-filtering apparatus of claim 3, wherein the batch type water-filtering apparatus controls the flow rate of the circulation water, based on a value measured by the circulation water flow meter.

6. The sequencing batch type or batch type water-filtering apparatus of claim 3, wherein the batch type water-filtering apparatus controls a degree of opening of the second automatic valve, based on a value measured by the circulation water flow meter.

7. The sequencing batch type or batch type water-filtering apparatus of claim 3, wherein the batch type water-filtering apparatus controls the rotation number of the raw water inflow pump, based on a value measured by the produced water flow meter.

8. A method of operating the sequencing batch type or batch type water-filtering apparatus of claim 1, which comprises the raw water storage tank, the inflow raw water tank, the raw water inflow pump, the membrane module comprising the tubular type membrane arrayed in series, and the produced water storage tank, the method comprising:
passing raw water, supplied from the raw water storage tank, through the membrane module via the inflow raw water tank, by using the raw water inflow pump;
discharging water produced through the passing through of the raw water, to an outside;
transferring concentrated water as circulation water to the inflow raw water tank through the circulation line; and
discharging a portion of mixed water comprising the raw water and the circulation water in the inflow raw water tank, to the outside,
wherein, when water is produced again after a backwashing operation, an initial degree of opening of a second automatic valve in the circulation line is adjusted to maintain a constant cross-flow velocity, and the rotation number of the raw water inflow pump is adjusted to control an amount of the produced water.

9. The method of claim 8, wherein the second automatic valve is operated at an initial degree of opening ranging from about 20 to 50%.

10. The method of claim 8, wherein, when water is produced again after the backwashing operation, the rotation number of the raw water inflow pump is the rotation number set in the latest process.

11. The method of claim 8, wherein the rotation number of the raw water inflow pump is increased or decreased by about 0.1 to 0.5 Hz.

12. The method of claim 8, wherein the rotation number of the raw water inflow pump is set to maintain a pressure difference of about 0.1 kgf/cm² or higher between front and rear pressure gauges connected to the membrane module.

13. The method of claim 8, wherein, when a temperature of the raw water in the inflow raw water tank is lower than a set temperature, and a concentration thereof is equal to or higher than a set concentration, a portion of the raw water is discharged as discharge water to the outside.

14. The method of claim 8, wherein, when a temperature of the raw water in the inflow raw water tank is equal to or higher than a set temperature, raw water is continually introduced until a level sensor in the inflow raw water tank senses a certain level.

15. The method of claim 8, wherein, when a temperature of the raw water in the inflow raw water tank is equal to or higher than a set temperature, raw water is intermittently introduced to the inflow raw water tank, and a difference between a raw water temperature before introducing the raw water and a raw water temperature after introducing the raw water is equal to or smaller than a set temperature difference.

16. The method of claim 8, wherein a temperature of the raw water in the inflow raw water tank is controlled to maintain the raw water introduced to the membrane module, at a constant temperature.
